(19) United States
(12) Patent Application Publication
(10) Pub. No.: US 2010/0221163 A1
(43) Pub. Date: Sep. 2, 2010

(54) METHOD TO SEQUESTER CO2 AS MINERAL CARBONATE

(75) Inventors: Herbert F. DaCosta, Peoria, IL (US); Maohong Fan, Ames, IA (US); Armistead Ted Russell, Atlanta, GA (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/394,565

(22) Filed: Feb. 27, 2009

(51) Int. Cl. B01D 53/62; B01J 8/18

(52) U.S. Cl. 423/230; 422/139

(57) ABSTRACT

A disclosed method for removing carbon dioxide from flue gases includes passing the carbon dioxide-containing through a bed of particulate material such as one or more metal silicates, alkaline earth metal oxides and combinations thereof. The carbon dioxide reacts with the particulate material to produce one or more metal carbonates and a carbon dioxide-depleted flue gas. A disclosed flue gas exhaust system includes a flue or exhaust conduit that houses a bed of particulate material so that at least some flue gas passing through the flue also passes through and makes contact with the bed. The particular material may be ground olivine or serpentine.

### TECHNICAL FIELD

This disclosure relates generally to a system and method for sequestering carbon dioxide from an exhaust stream by direct mineral carbonization. More specifically, this disclosure relates to a system and method for passing flue gas containing carbon dioxide through a bed of particulate material that includes a mineral capable of being carbonized by exposure to carbon dioxide to produce one or more carbonates thereby producing a carbon dioxide-depleted exhaust stream.

### BACKGROUND

Rising levels of carbon dioxide (CO₂) in the atmosphere have prompted concerns about global warming. To address these concerns, the amounts of CO₂ released to the atmosphere should be lowered. The primary approaches under consideration include: improving energy efficiency when fossil fuels are employed; making greater use of non-fossil fuel sources; and developing viable technologies for the capture, separation, and long-term storage of CO₂. The latter strategy, known as “CO₂ sequestration,” is receiving increased attention because it permits continued use of readily available and relatively inexpensive fossil fuels while reducing the amounts of CO₂ released to the atmosphere.

One technique for CO₂ sequestration is injection of CO₂ gas into underground reservoirs, e.g., active or depleted oil and gas fields, deep brine formations, and subterranean coal beds. The underlying premise of this approach is that, after injection, the CO₂ will remain sequestered in the host rock indefinitely. In practice, however, such long-term reservoir integrity cannot be guaranteed. Specifically, if either CO₂ or CO₂-saturated formation water escapes or migrates from the reservoir, water supplies could become contaminated, and/or large amounts of CO₂ could be released to the atmosphere. The possibility of CO₂ release back into the atmosphere requires continuous monitoring of such underground reservoirs which, in turn, increases the cost of underground CO₂ injection strategies. Further, suitable underground reservoirs are limited in number and may be difficult to access for delivery of the CO₂.

One way to avoid the reservoir-integrity problems associated with subterranean sequestration of CO₂ is to chemically bind CO₂ with suitable solid materials. This CO₂ sequestration strategy, known as “mineral carbonation,” involves reacting CO₂ with mineral oxides (e.g., CaO, MgO) or silicates (e.g, olivine, serpentine, talc) to produce solid carbonate compounds, such as calcite (CaCO₃), magnesite (MgCO₃), iron carbonates (FeCO₃, Fe₂(CO₃)₂), etc.

To date, mineral carbonations include a chemical process carried out in a slurry, at elevated pressures and in a separate reactor. In one example provided by U.S. Patent Application Publication No. 2004/0126293, entitled “Process for Removal of Carbon Dioxide from Flue Gases,” CO₂ is first extracted from a flue gas using an aqueous amine solution. The CO₂-containing amine solution is then heated to regenerate the amine solution and separate the CO₂ from the amine solution to provide a CO₂-rich gas stream. Then, the CO₂-rich gas stream is contacted with an aqueous slurry of magnesium silicate in a separate reactor which results in carbonation of the magnesium silicates and removal the CO₂ from the gas stream. Electrolytes in the form of one or more salts are added to the slurry to increase the mineral carbonization reaction rate.

Mineral carbonation has advantages over alternative methods for large-scale CO₂ sequestration. First, mineral carbonates are thermodynamically stable need not be monitored for CO₂ release. Further, mineral carbonates are environmentally benign and weakly soluble in water. Consequently, mineral carbonates can be used to reduce acidity and/or increase moisture content of soil, can be combined with other materials to strengthen roadbeds, can be used as a filler in the carpet and plastic industries, can be used in mine reclamation or simply dumped in a landfill. Alternatively, the mineral carbonates could be returned to the site of excavation to fill the cavity created by soil/rock removal. Regardless of the particular end use or disposal scheme selected for the carbonates, the reacted CO₂ will remain as carbonates and be immobilized for an indefinite period of time.

In weighing the economic and technical feasibility of CO₂ sequestration by mineral carbonation, it should be noted the magnesium-rich minerals olivine, serpentine and talc, are readily available. Olivine and serpentine can be carbonated by the following reactions:

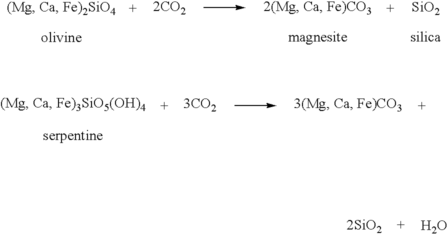

However, disadvantages of current mineral carbonation processes include: (1) the need to separate the CO₂ from a flue gas and transport the separated and compressed CO₂ to a separate carbonization reactor; (2) the need to heat-treat the olivine or serpentine prior to carbonization; (3) the elevated temperatures (e.g.,155° C.) and pressures (e.g., 185 atm) required; (4) the need for a separate carbonization reactor which may or may not be disposed close to the source of the CO₂ emissions; (5) the water requirements of the carbonization reactions which are typically carried out in an aqueous slurry as well as the aqueous solvents used to separate the CO₂ from the flue stream; and (6) the additives and/or catalysts that are usually required to accelerate the mineral carbonization reaction rate.

Accordingly, an improved mineral carbonation process is needed for the economical and convenient sequestration of CO₂ from a flue or exhaust stream.

### SUMMARY OF THE DISCLOSURE

Improved methods for removing carbon dioxide from an exhaust or flue stream are disclosed. In one disclosed method, flue gas that includes carbon dioxide is passed through a bed of particulate material. The bed of particulate material may be disposed directly in the flue or flue conduit so that at least some or all of the flue gas passes through the bed of particulate material. The particulate material includes one or more materials that are carbonized upon exposure to carbon dioxide. The particulate material may be selected from the group consisting of metal silicates, alkaline earth metal oxides and combinations thereof. By passing the flue gas that includes carbon dioxide through the bed of particulate material, the carbon dioxide reacts with the particulate material to produce one or more metal carbonates and a carbon dioxide-depleted flue gas.

Improved flue gas exhaust systems are also disclosed. In one disclosed system, a flue is provided that houses a bed of particulate material. The particulate material may be selected from the group consisting of metal silicates, alkaline earth metal oxides and combinations thereof. The bed may be disposed within the flue so that at least some flue gas passing through the flue also passes through and makes contact with the bed of particulate material. The bed may include an inlet end for receiving carbon dioxide-rich flue gas and an outlet end for releasing carbon dioxide-depleted flue gas.

### BRIEF DESCRIPTION OF THE DRAWINGS

FIG. 1 is an elevational view of a flue equipped with a bed of particulate mineral material that can be carbonized by carbon dioxide in the flue gas as well as a system for injecting fresh particulate mineral material into the bed and for withdrawing carbonized mineral material from the bed.

FIG. 2 is an elevational view of a flue equipped with a rotary table that accommodates a plurality of beds or cartridges of particulate mineral material wherein the rotary table can be rotated to remove a carbonized bed of particulate mineral material for replacement with an un-carbonized bed of particulate mineral material.

FIG. 3 is an elevational view of the flue and rotary table of FIG. 2.

FIG. 4 graphically illustrates the efficacy of using ground olivine in the presence of water in a bed for removing carbon dioxide from a gas stream containing water vapor at various temperatures.

FIG. 5 graphically illustrates the efficacy of using ground olivine in a bed for removing carbon dioxide from a gas stream containing water vapor at various temperatures.

FIG. 6 graphically illustrates the efficacy of using ground olivine in a bed for removing carbon dioxide from a gas stream without water vapor at various temperatures.

FIG. 7 graphically illustrates the efficacy of using ground olivine in a bed for removing carbon dioxide from a gas stream with and without water vapor at various temperatures.

### DETAILED DESCRIPTION

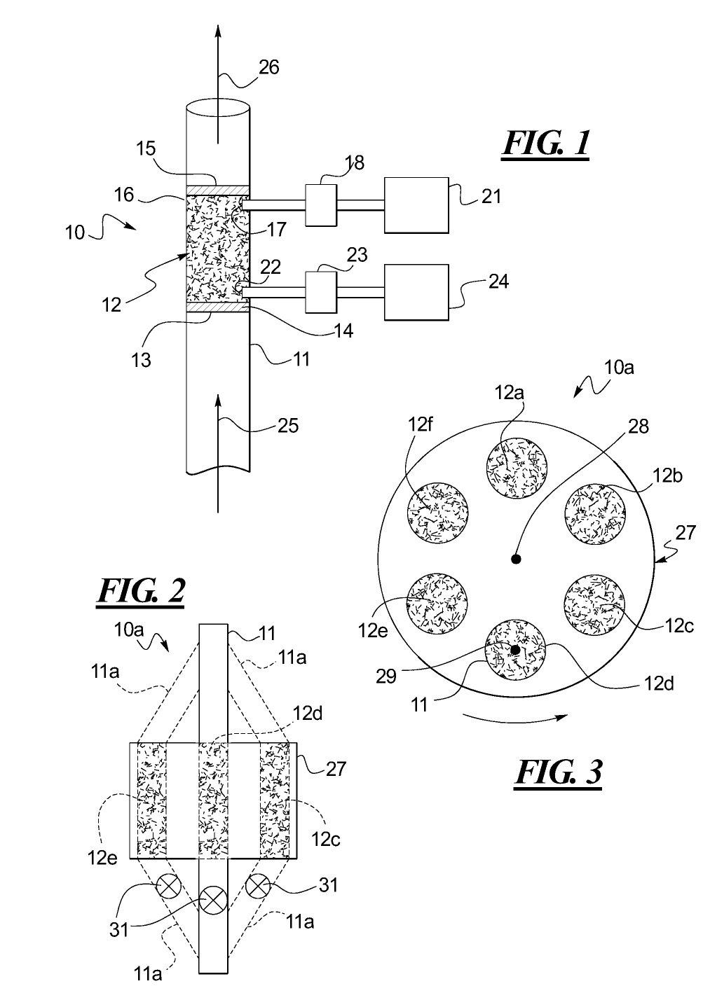

Referring to FIG. 1, an exhaust system 10 is disclosed which includes a flue or exhaust pipe 11 that is equipped with a bed 12 of mineral particulate material that is capable of being carbonated by carbon dioxide gas at typical exhaust temperatures ranging from about 100° C. to about 500° C. As used herein, the term “about,” when used to modify a numerical value, means plus or minus ten percent (±10%) of the stated value. The bed 12 may include a lower inlet end 13 that includes a grate or screen 14 or other supporting structure and an upper outlet end 15 that similarly may include a grate or screen 16 for maintaining the integrity of the bed 12. The grates or screens 14, 16 permit the flow of flue gas through the bed 12 but maintain or retain the particulate material within confines of the bed 12. In the example shown in FIG. 1, the bed 12 may be vertically oriented in the flue 11 so that the flue gas makes contact with the bed 12 at its lower inlet end 13 prior to exiting the bed 12 through its upper outlet end 15.

As the mineral particulate material becomes carbonated by the carbon dioxide in the flue gas, it may be replaced. Accordingly, an injection port 17 may be provided near the upper grate 16 for delivering fresh or un-carbonized mineral particulate material to the bed 12. The injection port 17 may be in communication with a pump or conveyor 18 as well as a supply 21 of fresh or un-carbonized mineral particulate material. Similarly, an evacuation port 22 may be disposed near the bottom grate 14 for evacuating spent material from the bed 12. The evacuation port 22 may be in communication with a pump or conveyor 23 and a disposal area 24. As flue gas containing carbon dioxide flows in the direction shown by the arrow 25 towards the bed 12, carbon dioxide reacts with the mineral particulate material of the bed 12 and the material becomes carbonated thereby reducing the amount of carbon dioxide that exits the flue 11 in the direction shown by the arrow 26.

It has been found that mineral carbonization reactions may proceed very quickly and therefore the lower portion of the bed 12 near the bottom grate 13 may have a higher concentration of carbonated mineral material than the upper portion of the bed 12 near the upper grate 15. Accordingly, in the embodiment shown in FIG. 1, the evacuation of material near the bottom grate 14 will cause un-carbonated material from upper portions of the bed 12 to fall downward under the force of gravity as the carbonated material from the lower portion of the bed 12 is evacuated through the port 22. Fresh material may be injected to the port 17 to replace material that falls downward through the bed 12 as material is evacuated through the port 22. The replenishment of material to the bed 12 may be done continuously or on an intermittent basis, depending upon a variety of factors including, but not limited to: the temperature of the flue gas passing through the flue 11; an amount of carbon dioxide present in flue gas; particle size or surface area of the mineral particulate material; flue gas flow rate; size or thickness of the bed 12; water content of the flue gas, etc. Various conveyor, auger, pump, cartridge and/or injection systems for replenishing the bed 12 or changing from a carbonized bed 12 to a fresh un-carbonized bed 12 will be apparent to those skilled in the art.

For example, another system for replenishing or replacing the bed 12 is illustrated in FIGS. 2 and 3. In FIGS. 2 and 3, a flue 11a may be equipped with a turntable 27 or other suitable structure that accommodates a plurality of beds 12a-12f. As the bed 12d that is in alignment with the flue 11 becomes carbonated, the table 27 can be rotated about its central axis 28 to replace the bed 12d with a fresh bed 12e. It will be noted that, in the system 10a of FIGS. 2 and 3, the axis 28 of the table 27 is offset from the axis 29 of the flue 11 as shown in FIG. 3. The beds 12a-12f may also be provided in the form of replaceable cartridges that may be changed out quickly using a structure like the rotary table 27 or other similar structure.

Alternatively, as shown in FIG. 2, instead of a rotary turntable structure 27, the flue 11 could include a plurality of routing conduits such as those shown in phantom at 11a and a plurality of valves such as those shown at 31. The flue gases could then be directed toward one or more of the beds 12a-12f and, when a bed becomes carbonated, valves 31 can be used to redirect the flue gases toward a fresh bed 12a-12f using one of the routing conduits 11a.

The bed 12 includes material that is capable of being carbonized with gaseous carbon dioxide either at typical exhaust temperatures or at a desired temperature that would be lower than the decomposition temperature of the carbonate. For magnesium-based minerals, a desired temperature would be less than 500° C.; for calcium-based minerals, a desired temperature would be less than 900° C. As surprisingly found below, olivine and serpentine are suitable magnesium-based materials that are relatively abundant, easy to obtain, and do not require costly heat pre-treatments prior to carbonization or grinding.

As noted above, prior art techniques for carbon dioxide sequestration through mineral carbonization suffer from many disadvantages not found in the disclosed methods or systems. Specifically, currently available mineral carbonization processes require the reaction to be carried out in an aqueous slurry and a feed gas with a high concentration of carbon dioxide. Typically, the carbon dioxide is separated from an exhaust gas stream, compressed and transported to the reactor where the carbonization reaction is carried out in the aqueous slurry. Obviously, the cost to separate the carbon dioxide and transport it to a separate reactor and the water costs associated with the slurry drive-up the overall cost of the mineral carbonization. No economically viable dry mineral carbonization process has been introduced. Further, mineral carbonization processes that utilize naturally occurring mineral reactants such as olivine or serpentine typically require the olivine or serpentine to be heat-treated or chemically-treated prior to use. Heat pre-treatments are energy intensive and drive-up the overall cost and fossil fuel use of the mineral carbonization. Chemical pre-treatments and the use of catalysts add costs and complexity to the mineral carbonization.

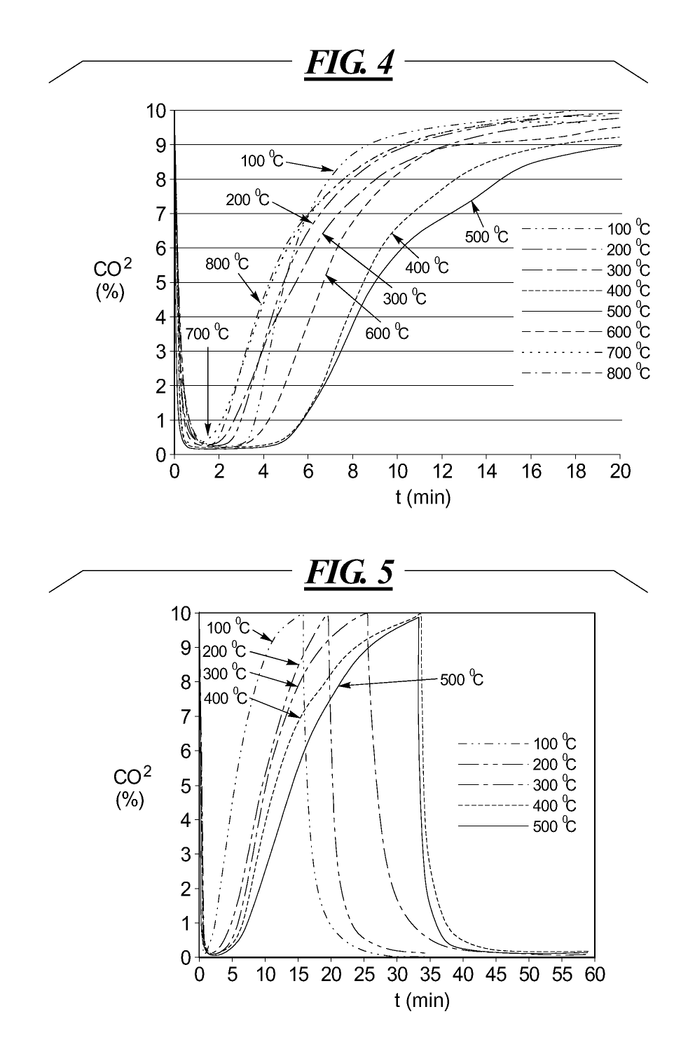

In contrast, FIGS. 4-7 establish the viability of the disclosed systems and methods whereby carbon dioxide is sequestered from a flue or exhaust gas stream by a mineral carbonization reaction carried out as the flue gases pass through a bed of particulate mineral material capable of being carbonized by carbon dioxide at temperatures ranging from about 100 to about 500° C. Specifically, the particulate mineral material may be magnesium-based minerals such as magnesium-based silicates such as olivine and serpentine. The particulate mineral material may also be calcium-based minerals and other alkaline-earth metal oxide materials (e.g. calcium oxide, beryllium oxide, strontium oxide, barium oxide, etc.). Further, the particulate mineral material may also include waste products such as steel slag that contains calcium oxide, magnesium oxide, calcium hydroxide, etc. Heat and/or chemical pre-treatment of the particulate mineral material before or after grinding are not necessary.

The material may be ground for use in either a packed or fluidized bed. It has been found that surface area per unit mass may be more relevant than particle size and therefore the material may be ground to a surface area per unit mass ranging from about 0.15 to about 35 m²/g. If surface area per unit mass data is unavailable, mean particle size can provide some guidance and the mean particle size can range from about 2.5 to about 60 μm, depending upon the mineral material being utilized.

FIG. 4, shows the CO₂ depletion curve using 5 g of natural olivine reactant ((Mg, Fe)₂SiO₄) at temperatures ranging from about 100 to about 800° C., a feed rate of about 0.5 L/min in a 1.9 cm diameter reactor, a feed composition of about 10% CO₂, 8.3% H₂O, balanced with N₂, and the olivine reactant having a surface area per unit mass of about 2.5 m²/g. As shown toward the left side of FIG. 4, the CO₂ concentration decreases rapidly during in the first minute and then increases considerably to about 9% CO₂ thereafter. The initial inlet concentration level (10% CO₂) was reached relatively slowly after the initial reaction. However, the minimum CO₂ concentrations at temperatures of 400 and 500° C. were lower (<0.2%) and lasted longer (>4.5 min) in comparison to the other temperatures tested. Further, at 600° C., the carbonation efficiency became lower than the carbonization obtained at 400° C. and the carbonizations at 700° C. and at 800° C. exhibited lower efficiencies than the carbonization at 200° C. At 700 and 800° C., it was observed that, after the carbonation reaction, the reactant color changed from gray to light red. This color change may be an indication of changes in reactant properties and/or formation of unwanted byproducts at the higher temperatures. The results of FIG. 4 reveal that the carbonation of olivine reactant satisfactorily occurs at temperatures below 500° C., while decomposition reactions may take place at temperatures higher than 500° C.

Referring now to FIG. 5, the same experimental conditions used for FIG. 4 were used to test the olivine reactant (2.5 m²/g) in a smaller reactor (d=0.95 cm), having a smaller bed (0.5 g versus 5.0 g) of olivine reactant. The feed rate remained at 0.5 L/min and the feed composition remained at about 10% CO₂, 8.3% H₂O, balanced with N₂. The CO₂ carbonation and regeneration curves for 0.5 g of olivine reactant tested in the range of 100 to 500° C. are shown in FIG. 5. For the regeneration, the inlet CO₂ gas stream was stopped and N₂ was passed through the bed without water vapor while the temperature remained constant. It can be seen that, as the temperature is increased from 100 to 500° C., the carbonation capacities of the olivine increase rapidly. The CO₂ concentration decreases significantly during the first minute and then quickly increases to the initial inlet CO₂ concentration level of 10%. However, the lowest CO₂ concentration in the exiting gas stream lasts longer when compared to the results achieved using 5 g of olivine as shown in FIG. 4. Specifically, above a temperature of 300° C., the CO₂ concentration range in the exit stream of ˜0.2 to ˜0.4% for the 0.5 g olivine bed lasts more than 10 minutes while the lowest CO₂ concentration in the exit stream using the 5 g olivine bed lasts less than 4.5 minutes.

In addition, the carbonation efficiency in the 100-500° C. range using 0.5 g olivine becomes significantly higher than the efficiency obtained using 5 g olivine. The CO₂ capture capacity of 0.5 g of olivine is approximately 2 g CO₂/g olivine, while the CO₂ capture capacity of 5 g of olivine is 0.12 g CO₂/g olivine. In comparison to commercially available reactants with CO₂ capture capacities of 0.08-0.088 g CO₂/g reactant, these results show that, under optimized operational conditions, even small amounts of olivine have a high CO₂ capture capacity and affinity.

In contrast to prior art processes that require the reaction to take place in an aqueous slurry, it has been surprisingly found that water vapor present in most hydrocarbon combustion flue gases provides a sufficient amount of water. As noted above, water is not a primary reactant for the mineral carbonization process. However, water vapor can be useful to convert oxides that may be present to hydroxides which may then be carbonated. An exemplary reaction sequence for magnesium oxide is shown below:

MgO+H₂O→Mg(OH)₂

Mg(OH)₂+CO₂→MgCO₃

Oxides may be present in mined material such as olivine and serpentine or may be generated as byproducts during the carbonation process. Hence, as shown below, the presence of some water may be beneficial but the disclosed methods exploit the presence of water vapor in hydrocarbon combustion flue gases thereby avoiding the necessity of adding water.

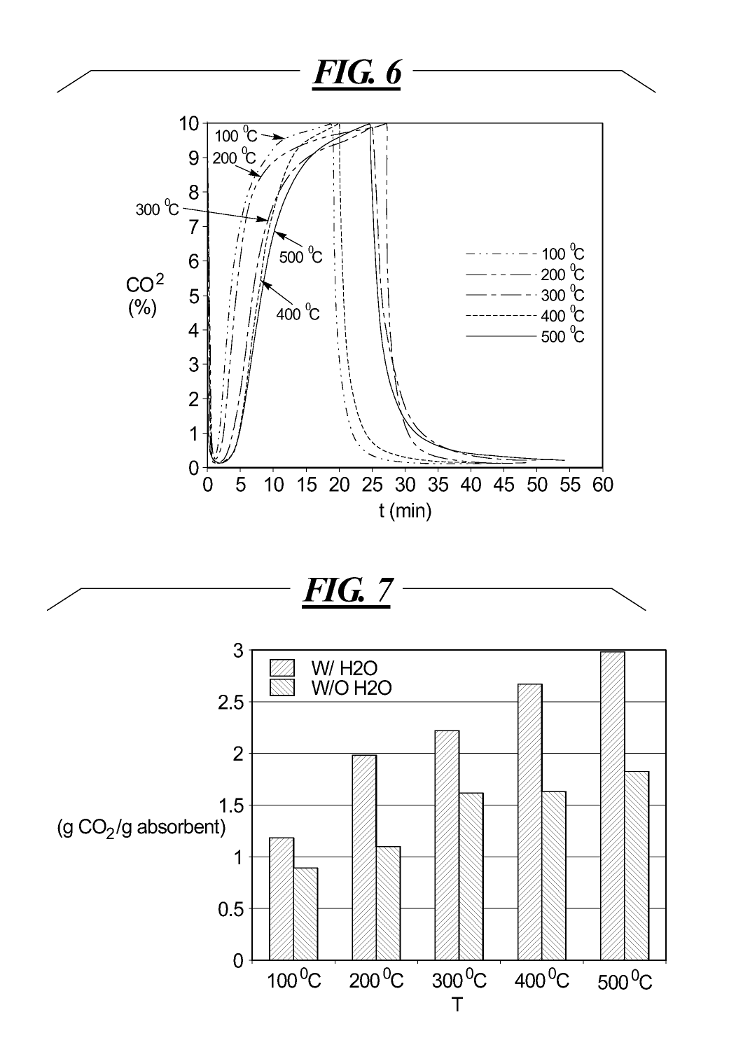

FIG. 6 illustrates a series of results using 0.5 g of olivine reactant without water vapor under the same experimental conditions for the results of FIG. 5. The CO₂ capture capacity increases when the temperature is raised to 500° C. However, the capture capacities in the absence of water vapor in the 100-500° C. temperature range may be smaller than those in the presence of water vapor. For example, as shown in FIG. 6, at 500° C., the minimum CO₂ concentration in the exit stream without water present lasts less than 5 minutes. In contrast, as shown in FIG. 5, at 500° C., the minimum CO₂ concentration in the without water present lasts greater than 5 minutes. Thus, the CO₂ carbonation using olivine without water vapor may be less than the carbonation using olivine with water vapor. However, because flue gases from a hydrocarbon combustion process includes water vapor, the addition of water to flue gases in the disclosed methods and systems is not required.

A comparison of with water vapor and without water vapor results for 0.5 g olivine beds is provided in FIG. 7. It will be noted that the CO₂ capture without the presence of water vapor appears to peak at about 300° C. while the CO₂ capture with the presence of water continues to increase up to about 500° C. This phenomenon may be explained by differences in the primary decomposition reactions of magnesium carbonate with and without the presence of water vapor. Specifically, solid magnesium carbonate can decompose in the presence of water vapor to solid magnesium hydroxide and carbon dioxide gas via the following reaction

MgCO₃(s)+H₂O (g)→Mg(OH)₂(s)+CO₂(g),

at temperatures above about 500° C. as the Gibbs free energy as a function of temperature becomes negative at temperatures exceeding about 500° C. In contrast, solid magnesium carbonate can decompose to solid magnesium oxide and carbon dioxide gas without the presence of water vapor via the following reaction

MgCO₃(s)→MgO(s)+CO₂(g),

at temperatures above about 305° C. as the Gibbs free energy as a function of temperature becomes negative at temperatures exceeding about 305° C.

On the other hand, using the same Gibbs free energy/temperature analysis, calcium carbonate can decompose to calcium hydroxide in the presence of water vapor at temperatures above about 1590° C. while calcium carbonate decomposes to calcium oxide without the presence of water vapor at temperatures above about 900° C. Therefore, mineral carbonations using calcium-based minerals can be carried out at substantially higher temperatures than mineral carbonations using magnesium-based minerals. Specifically, because calcium carbonate will not decompose at temperatures of less than about 900° C., mineral carbonizations employing calcium-based minerals can be carried out at temperatures less than about 900° C.

Suitable calcium-based minerals include, but are not limited to calcium silicate, wollastonite (calcium metasilicate—CaSiO₃), bredigite (Ca₇Mg(SiO₄)₄), rankinite (Ca₃Si₂O₇), minerals comprising mixtures of Ca₂SiO₇ and CaCO₃, such as tilleyite (Ca₅Si₂O₇(CO₃)₂), and spurrite (Ca₅(SiO₄)₂(CO₃)).

### INDUSTRIAL APPLICABILITY

A packed or fluidized bed 12 like those shown in FIGS. 1-3 may be particularly suitable for exhaust flues 11 of coal-fired or gas-fired power plants. The exhaust streams from such plants will have some water vapor and will typically be at a temperature of less than 500° C. Hence, the disclosed systems may be used to retrofit existing coal or gas-fired power plants or be used in new plant design. The disclosed systems and methods may also be applied to any exhaust stream containing significant amounts of carbon dioxide and is not limited to power plants or plants that burn fossil fuels.

By avoiding the need for a mineral carbonization process carried out in an aqueous slurry, the disclosed systems and methods reduce water consumption and the costs associated therewith. The disclosed systems and methods also avoid the need to separate carbon dioxide from a flue stream and transport the separated carbon dioxide to a separate reactor. The costs associated with constructing and maintaining a separate reactor may also be avoided as the disclosed systems and methods may be practiced by simply retrofitting an existing flue or exhaust and or can be easily and economically installed as original equipment in new plants. Further, carrying out a mineral carbonization at the source of carbon dioxide production eliminates disadvantages associated with separating, storing and transporting carbon dioxide which is required for subterranean sequestration and other mineral carbonization processes.

What is claimed is:

1. A method for removing carbon dioxide from flue gas, comprising:
passing the flue gas including this carbon dioxide through a bed of particulate material selected from the group consisting of metal silicates, alkaline earth metal oxides and combinations thereof; and
reacting the carbon dioxide with the particulate material to produce one or more metal carbonates and a carbon dioxide-depleted flue gas.

2. The method of claim 1 further including removing said one or more metal carbonates from the bed and adding fresh particulate material to the bed.

3. The method of claim 1 wherein the particulate material has a surface area per unit mass ranging from about 0.15 to about 35 m²/g.

4. The method of claim 1 wherein the particulate material includes at least one magnesium-based mineral and the reacting of the carbon dioxide with the particulate material is carried out at a temperature less than about 500° C.

5. The method of claim 1 wherein the particulate material includes at least one calcium-based mineral and the reacting of the carbon dioxide with the particulate material is carried out at temperatures less than about 900° C.

6. The method of claim 1 further including adding water vapor to the flue gas prior to the flue gas contacting the bed of particulate material.

7. The method of claim 6 wherein the water vapor is added to the flue gas an amount ranging from about 6 to about 18% of the flue gas.

8. The method of claim 1 wherein the particulate material is selected from the group consisting of olivine, serpentine, talc, wollastonite, bredigite, rankinite, tilleyite, spurrite and combinations thereof.

9. The method of claim 1 wherein the particulate material is ground to particles having a surface area per unit mass ranging from about 0.15 to about 35 m²/g and wherein the particulate material is not heat-treated prior to grinding or prior to being placed in the bed.

10. The method of claim 2 wherein the removing of the one or more metal carbonates from the bed and adding fresh particulate material to the bed includes continuously removing material from a bottom of the bed where flue gas enters the bed and adding fresh particulate material to a top of the bed where flue gas exits the bed.

11. The method of claim 1 wherein the bed further includes a cartridge comprising an inlet and an outlet, and the method further includes regularly replacing the cartridge with a fresh cartridge.

12. A flue gas exhaust system comprising:
a flue housing a bed of particulate material selected from the group consisting of metal silicates, alkaline earth metal oxides and combinations thereof, the bed of particulate material disposed in the flue so that at least some flue gas passing through the flue also passes through and makes contact with the bed of particulate material, the flue gas including carbon dioxide; and
the bed including an inlet end for receiving the flue gas including carbon dioxide and an outlet end for releasing carbon dioxide-depleted flue gas.

13. The flue gas exhaust system of claim 12 wherein the bed of particulate material further includes one or more materials selected from the group consisting of olivine, serpentine, talc, wollastonite, bredigite, rankinite, tilleyite, spurrite and combinations thereof.

14. The flue gas exhaust system of claim 12 wherein the particulate material is not heat-treated prior to placement in the bed and exposure to flue gas.

15. The flue gas exhaust system of claim 12 wherein the particulate material is ground to particles having a surface area per unit mass ranging from about 0.15 to about 35 m²/g.

16. The flue gas exhaust system of claim 12 wherein the inlet end of the bed is disposed vertically below the outlet end of the bed, the system further including an evacuation port disposed adjacent to the inlet end of the bed for removing metal carbonates from the bed, the system further including an injection port disposed adjacent to the outlet end of the bed for injecting fresh particulate material into the bed.

17. The flue gas exhaust system of claim 12 wherein the particulate material includes at least one magnesium-based mineral and the flue gas is delivered to the inlet end of the bed of particulate material at a temperature of less than about 500° C.

18. The flue gas exhaust system of claim 12 wherein the particulate material includes at least one calcium-based mineral and the flue gas is delivered to the inlet end of the bed of particulate material at a temperature of less than about 900° C.

19. A method for removing carbon dioxide from flue gas, comprising:
mining one or more minerals that include one or more materials selected from the group consisting of metal silicates, alkaline earth metal oxides and combinations thereof;
grinding said one of more minerals into particles having a surface area per unit mass ranging from about 0.15 to about 35 m²/g;
fabricating a bed from the particles and placing the bed in a flue;
passing the flue gas including carbon dioxide through the bed of particles; and
reacting the carbon dioxide with the particles to produce one or more metal carbonates and a carbon dioxide-depleted flue gas.

20. The method of claim 19 further including removing said one or more metal carbonates from the bed and adding fresh particles to the bed.
